(19) United States
(12) Patent Application Publication
(10) Pub. No.: US 2007/0196699 A1
(43) Pub. Date: Aug. 23, 2007

(54) Silicon substrate for magnetic recording medium, manufacturing method thereof, and magnetic recording medium

(75) Inventor: Katsuaki Aida, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/659,702

(22) PCT Filed: Aug. 4, 2005
(86) PCT No.: PCT/JP05/14708

§ 371 Date: Feb. 8, 2007

Related U.S. Application Data
(60) Provisional application No. 60/603,272, filed on Aug. 23, 2004.

(30) Foreign Application Priority Data
Aug. 11, 2004 (JP) 2004-234366
Apr. 20, 2005 (JP) 2005-122175

(51) Int. Cl. G11B 5/706; B24B 7/30; B24B 1/00

(52) U.S. Cl. 428/846.1; 428/848.2; 428/848.6; 451/41

(57) ABSTRACT

A silicon substrate for magnetic recording medium is provided, which, even though it is a silicon substrate of a fragile material, is not prone to chip on the substrate edge faces or cracks on the substrate, and which prevents debris from being produced from the substrate edge faces, and which prevents debris from being produced by rubbing against a process cassette. Therefore, in a silicon substrate for a magnetic recording medium, in which there is provided a chamfer section between a main surface of the substrate and an edge face, the edge face and chamfer section of the substrate are of mirror finish, and a curved surface with a radius of greater than or equal to 0.01 mm and less than 0.3 mm is interposed between the main surface of the substrate and the chamfer section. In forming the curved surface, a silicon substrate stack with a plurality of silicon substrates and spacers laminated is prepared, and the inner periphery of a central hole of the substrates, and an outer periphery of the substrates are brush polished.

### TECHNICAL FIELD

The present invention relates to a silicon substrate for a small size magnetic recording medium, which is used as a recording medium for information-processing equipment.

Priority is claimed on Japanese Patent Application No. 2004-234366, filed Aug. 11, 2004, Japanese Patent Application No.2005-122175, filed Apr. 20, 2005, and U.S. Provisional application No. 60/603,272, filed Aug. 23, 2004, the content of which are incorporated herein by reference.

### BACKGROUND ART

As the range of information equipment has expanded in recent years, the memory capacity of magnetic recording media has continued to increase. Especially, magnetic discs which play a major role as the external memory of computers, increase their memory capacity and memory density year by year. However, development is required in order to perform higher density recording. For example, due to the development of notebook type personal computers and palm top personal computers, a small sized and impact resistant recorder is desirable. Therefore, a small size magnetic recording medium that enables higher density recording and has great mechanical strength is desirable. Furthermore, in recent years, subminiature magnetic recording media have been used for some navigation systems and portable music reproducing units.

Heretofore, a materials including an aluminum alloy, an aluminum alloy having a plated layer of NiP, or glass substrates, has been used as substrates for magnetic discs, serving as magnetic recording media. However, aluminum alloy substrates have poor wear resistance and low workability, so a NiP plating is applied to an aluminum substrate in order to compensate for these drawbacks. However, the aluminum alloy having a NiP plating layer thereon has still drawbacks in that they can bend easily, they may be magnetized, during high temperature process, and so forth. Furthermore, glass substrates have a problem in that a layer of stress occurs on the surface at the time of tempering for strengthening, and the compressive stress formed on the glass substrate, so that the glass substrate is easily deformed when the substrate is heated.

In the case of a subminiature magnetic recording medium of 1 inch (25.4 mmØ) or 0.85 inch (21.6 mmØ) in diameter, capable of recording at high density, bending of a substrate is a catastrophic defect. For a substrate of a subminiature magnetic recording medium, a material is desirable that is thin, difficult to be deformed by external force, that has a flat surface, and on which a magnetic recording layer can be formed easily.

Therefore, it is proposed to use a silicon substrate, which is used frequently as a semiconductor device substrate, as a magnetic recording medium (for example, refer to Japanese Unexamined Patent Application, First Publication No. 06-76282).

Single crystal silicon has a lot of merits, such as a lower density, a higher Young's modulus, a smaller thermal expansion coefficient, and better elevated temperature properties, than aluminum, and is electrically conductive. Therefore, it is desirable as a substrate material for a magnetic recording medium. Moreover, the smaller the diameter of a substrate, the lower the impact force, and thus it is possible to make a durable magnetic recording device even if a silicon substrate is used.

Normally, in order to manufacture a substrate for a magnetic recording medium, firstly, a single crystal silicon ingot is produced using the Czochralski method. Next, an open hole is made in its center, and then it is sliced to a predetermined thickness. The sliced doughnut-shaped disc is, for its use, finished to a mirror surface by chamfering its central hole and the edge section of its outer periphery using a grinder or the like, and then lapping and polishing the front and back surfaces, the outer peripheral edge face, and the chamfer section.

Since the silicon material of the silicon substrates is fragile, there is a problem in that while they go through the above-described manufacturing processes, cracks and chips are produced easily. If cracks or chips are produced, not only does it cause a reduction in the yield of magnetic recording media manufacturing, but also the particles produced cause errors during recording and reproduction, and cause crashes of a magnetic head during recording and reproduction.

In order to obtain substrates for magnetic recording media from fragile materials with no cracks or chips, a method is proposed in which the chamfer angle of the inner periphery of the central hole of the substrate, and the outer periphery of the substrate, are greater than or equal to 20 degrees and less than or equal to 24 degrees, and the chamfer length is made greater than or equal to 0.03 mm and less than or equal to 0.15 mm (for example, refer to Japanese Unexamined Patent Application, First Publication No. 07-249223).

By forming substrates with the above-described form, cracks, chips and the like, on the substrates, caused by handling or dropping during the manufacturing process, can be reduced. Thus the manufacturing yield is improved significantly.

Furthermore, regarding glass substrates, in order to achieve high density recording, it is devised that the magnetic head floats more closely above the magnetic recording medium, and the method of recording and reproduction is being changed gradually from the contact start stop (CSS) method to the load and unload method (ramp load method). These recording and reproduction methods also require substrates with high installation reliability, that have no errors during recording and reproduction, and no crash of magnetic heads during recording and reproduction.

For a substrate that satisfies this object, a substrate is proposed that interposes a curved surface with a radius of greater than or equal to 0.003 mm and less than 0.2 mm between at least the edge faces of the substrate inner and outer peripheries, and the chamfer section, or between the main surface of the substrate and the chamfer section (for example refer to Japanese Unexamined Patent Application, First Publication No. 2002-100031).

Using this substrate, it is possible to obtain a magnetic recording medium with high installation reliability, with which there is no error during recording and reproduction, and no crash of the magnetic head during recording and reproduction.

[Patent Document 1] Japanese Patent Application, First Publication No. Hei 06-76282

[Patent Document 2] Japanese Patent Application, First Publication No. Hei 07-249223

[Patent Document 3] Japanese Patent application, First Publication No. 2002-10031

### DISCLOSURE OF INVENTION

However, since silicon substrates are fragile, with substrates of the shape disclosed in Japanese Patent Application, First Publication No. Hei 07-249223 and Japanese Patent application, First Publication No. 2002-10031, the substrate edge faces are mounted in substrate receptacles in a process cassette. Therefore, chips occur on the substrate edge faces and cracks occur on the substrates due to shocks during transport, and particle contamination occurs from debris of silicon powder produced by rubbing against the process cassette, causing defective magnetic recording media products to occur.

Therefore, an object of the present invention is to provide a substrate, which even though it is a silicon substrate of a fragile material, is not prone to chips being produced on the substrate edge faces or cracks on the substrate, and to provide a substrate shape that can prevent debris from being produced from the substrate edge faces, and prevent debris from being produced by rubbing against a process cassette.

In order to solve the above-described problems, the following inventions are provided: (1) a silicon substrate for a magnetic recording medium, in which there is provided a chamfer section between a main surface of the substrate and an edge face, wherein the edge face and chamfer section of the substrate are of mirror finish, and a curved surface with a radius of greater than or equal to 0.01 mm and less than 0.3 mm is interposed between the main surface of the substrate and the chamfer sections; (2) a silicon substrate for a magnetic recording medium according to (1), wherein the chamfer section between the main surface and the edge face is on an outer peripheral side of the substrate; (3) a silicon substrate for a magnetic recording medium according to (1) or (2), wherein the chamfer sections between the main surface and the edge face is on an inner peripheral side of the substrate, (4) a silicon substrate for a magnetic recording medium according to any of (1) to (3), wherein a length of the chamfer section is 0.05 to 0.16 mm; (5) a silicon substrate for a magnetic recording medium according to any one of (1) to (4), wherein the silicon substrate is a disc-shaped substrate with a circular hole in the center, and a dimensional accuracy of a diameter of the circular hole in the center is within ±20 μm; (6) a silicon substrate for a magnetic recording medium according to any one of (1) to (5), wherein a surface roughness of the edge face and the chamfer section is less than or equal 1 μm Rmax; (7) a silicon substrate for a magnetic recording medium according to any one of (1) to (6), wherein a surface roughness of the main surface of the substrate is less than or equal to 10 nm Rmax; (8) a method of manufacturing a silicon substrate for a magnetic recording medium, comprising: a process for immersing a disc-shaped silicon substrate with a circular hole in its center in a polishing liquid containing free abrasive grain, and polishing an outer peripheral edge face and/or an inner peripheral edge face of the silicon substrate by rolling contact with a polishing brush; (9) a method of manufacturing a silicon substrate for a magnetic recording medium according to (8), wherein the polishing process by rolling contact with a polishing brush is performed after chamfering the inner and outer peripheries; (10) a method of manufacturing a silicon substrate for a magnetic recording medium according to (8) or (9), wherein a brush made from polyamide resin is used as the above-described polishing brush; and (11) a magnetic recording medium completed by forming at least a magnetic layer on a main surface of a silicon substrate for a magnetic recording medium according to any one of (1) to (7).

According to the present invention, in a silicon substrate for a magnetic recording medium in which chamfer sections are provided between the main surface and the edge faces of the substrate, the edge faces and the chamfer sections of the substrate are of a mirror finish and a curved surface of greater than or equal to 0.01 mm and less than 0.3 mm radius is interposed between the main surface and the chamfer sections of the substrate. Therefore the corners of the substrate are smooth, the corners of the substrate do not chip off, there is no occurrence of particles from the substrate, and debris from rubbing against the process cassette can be prevented. Hence it is possible to reduce the rate of defective magnetic recording media occurring, and prevent errors occurring during recording and reproduction.

### BRIEF DESCRIPTION OF THE DRAWINGS

FIG. 1 is a cross-sectional perspective diagram of a silicon substrate for a magnetic recording medium of the present invention.

FIG. 2 is a diagram to explain the dimensioning of the parts of the silicon substrate for the magnetic recording medium shown in FIG. 1.

FIG. 3 is a diagram showing an enlarged outer peripheral section of the silicon substrate for the magnetic recording medium of the present invention shown in FIG. 1.

FIG. 4 is a diagram to explain a method of measuring the radius R of a curved surface.

FIG. 5 is a diagram showing part of a stack of silicon substrates used in the present invention.

FIG. 6 is a diagram to explain a method of polishing the inner periphery of the central hole of the silicon substrates using a brush.

FIG. 7 is a diagram to explain a method of polishing the outer periphery of the silicon substrates using a brush.

### BEST MODE FOR CARRYING OUT THE INVENTION

Hereunder is a detailed description of the present invention.

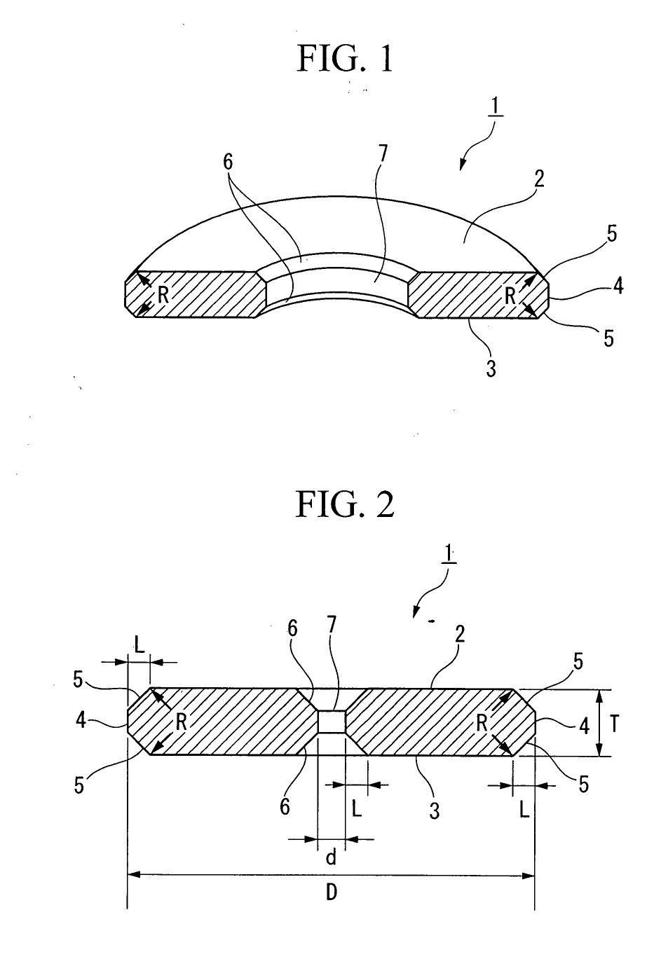

FIG. 1 is a perspective view of a sectioned silicon substrate for a magnetic recording medium. Furthermore, FIG. 2 is a diagram illustrating each of the dimensions of the silicon substrate for a magnetic recording medium of the present invention as shown in FIG. 1.

As shown in FIG. 1, a silicon substrate 1 for a magnetic recording medium 1 is formed from a doughnut-shaped disc. On the front and the back of the disc there are main surfaces 2 and 3 for making magnetic recordings. Outer peripheral chamfer sections 5 are formed between the main surfaces 2 and 3 and an outer peripheral edge face 4, and inner peripheral chamfer sections 6 are formed between the main surfaces 2 and 3 and an inner peripheral edge face 7.

Each of the main surfaces 2 and 3, the outer peripheral edge faces 4, the inner peripheral edge faces 7, the outer peripheral chamfer sections 5, and the inner peripheral chamfer sections 6, is polished to a mirror surface.

Furthermore, in the silicon substrate for a magnetic recording medium 1 of the present invention, curved surfaces with a radius R of greater than or equal to 0.01 mm and less than 0.3 mm are formed at the intersections of the main surfaces 2 and 3 and the outer peripheral chamfer sections 5, and the intersections of the main surfaces 2 and 3 and the inner peripheral chamfer sections 6.

By providing the curved surfaces described above, the corner sections of a silicon substrate of a fragile material do not get chipped, thus reducing the occurrence of chips, defective magnetic recording media products caused by particle contamination due to debris produced by rubbing against the process cassette, and the occurrence of errors during recording and reproduction.

FIG. 2 shows the dimensions of each of the parts of the silicon substrate for a magnetic recording medium 1 of the present invention. In the figure, D denotes the outer diameter of the substrate, d denotes the inner diameter of the substrate central hole, T denotes the thickness of the substrate, and L denotes the length of the chamfer section. Table 1 shows an example of measurements of each of the sections of a silicon substrate for a magnetic recording medium, being an object of the present invention. As shown in Table 1, for a substrate of 0.85 inch to 3.5 inch diameter, an appropriate radius R for the curved surface is 0.01 mm to 0.3 mm.

TABLE 1
Units: mm

| | | Substrate | | |
|---|---|---|---|---|
| Substrate | Substrate outer | circular hole | Substrate | Chamfer |
| nominal | diameter | inner diameter | thickness | section length |
| Inches | (D) | (d) | (T) | (L) |
| 0.85 | 21.6 | 6 | 0.381 | 0.07 |
| 1 | 27.6 | 7 | 0.381 | 0.07 |
| 1.89 | 48 | 12 | 0.508 | 0.12 |
| 2.5 | 65 | 20 | 0.635 | 0.15 |
| 3.3 | 84 | 25 | 1.27 | 0.15 |
| 3.5 | 95 | 25 | 1.27 | 0.15 |

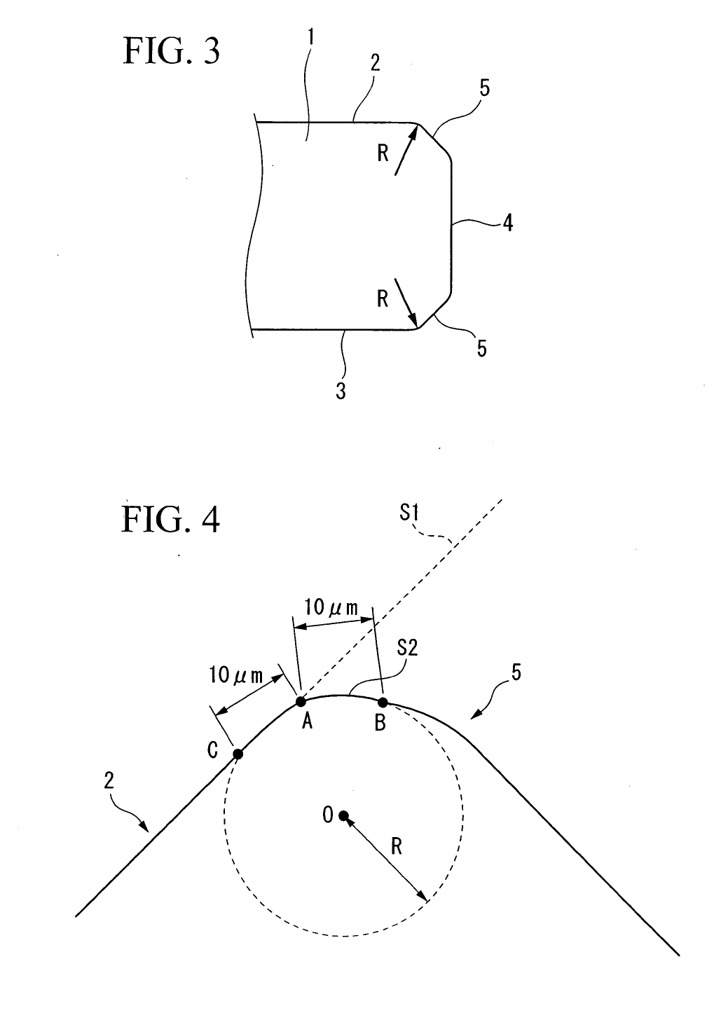

FIG. 3 shows an enlarged diagram of the outer peripheral section of the silicon substrate for a magnetic recording medium 1 of the present invention. The outer peripheral chamfer sections 5 are formed between the main surfaces 2 and 3 and the outer peripheral edge face 4 of the silicon substrate for a magnetic recording medium 1 of the present invention, and curved surfaces with a radius R of greater than or equal to 0.01 mm and less than 0.3 mm are formed at the intersections of the main surfaces 2 and 3 and the outer peripheral chamfer sections 5.

Furthermore, similarly, curved surfaces with a radius R of greater than or equal to 0.01 mm and less than 0.3 mm are formed at the intersections of the main surfaces 2 and 3 and the inner peripheral chamfer sections.

Here is a description of a method of measuring the radius R of the curved surface, with reference to FIG. 4. As shown in FIG. 4, an extension line S1 is drawn from the main surface, and the location at which the extension line S1 and the curved surface S2 separate is designated origin A. Locations 10 μm away from the origin A are designated point B, and point C. The radius R of a circle O, which passes through the three points A, B and C, is equal to the radius R of the curved surface. If the radius R of the curved surface is greater than or equal to 0.01 mm and less than 0.3 mm, it is possible to prevent the corner part of the silicon substrate from chipping and falling. If R is less than 0.01, the corner is too sharp, so it will weaken on impact, and it may be chipped easily during handling, or if it is knocked. If R is greater than 0.3 mm, the area of the main surface which records information is reduced, which is not desirable. It is desirable to provide curved surfaces with a radius R between both the main surface and the outer peripheral chamfer section, and the main surface and the inner peripheral chamfer section.

A curved surface with a radius of 0.01 mm to 0.3 mm can be used for silicon substrates of any size. However, it is especially effective for a substrate of 0.85 inch to 2.5 inch diameter.

For these silicon substrates, the appropriate length of the chamfer sections 5 and 6 is 0.15 mm to 0.19 mm. This is to ensure sufficient area of the main surface, which records information.

Furthermore, in the silicon substrate for a magnetic recording medium of the present invention, the main surface, the outer peripheral edge face, the inner peripheral edge face, the outer peripheral chamfer section, and the inner peripheral chamfer section, are polished to a mirror finish.

The roughness of the main surface is less than or equal to 10 nm Rmax. Moreover, the roughness of the outer and inner peripheral edge faces, and the inner and outer peripheral chamfer sections is less than or equal to 1 μm Rmax.

The accuracy of the diameter of the central hole of the silicon substrate is required to be controlled to within ±20 μm.

The silicon substrate having curved surfaces with the radius R as described above can be obtained by polishing the inner and outer peripheral surfaces using a polishing brush.

Normally, a silicon substrate is manufactured using the following process. That is, firstly, a lapping process is performed on the disc-shaped silicon material with an aim of improving the form accuracy and the dimensional accuracy. The lapping process is performed in two stages using a lapping device, and the profile irregularity is finished to reach less than or equal to 1 μm, and the surface roughness to reach less than or equal to 6 μm Rmax.

Since the silicon substrate that is normally obtained after performing the first stage lapping process is larger than a substrate for a magnetic recording medium, a substrate that has appropriate inner and outer diameters is cut out using a laser scriber.

Afterward, predetermined chamfer processing is performed on the outer periphery and the inner periphery. At this time, the surface roughness of the inner and outer peripheral edge faces is approximately 4 μm Rmax.

Next, the second stage lapping process is performed to make the profile irregularity less than or equal to 1 μm, and the surface roughness less than or equal to 6 μm Rmax.

Next, the inner and outer peripheral chamfer sections are polished, and finished to a mirror finish. Finally, the main surfaces on which magnetic recording layers are provided are polished. The polishing processes are performed in two stages of a first polishing for removing scratches and distortion produced during the processes up to that time, and a second polishing process for finishing to a mirror finish.

In this manner, silicon substrates for magnetic recording media are obtained.

In the present invention, after grinding the outer peripheral edge faces and the chamfer sections, the inner peripheral edge faces and the outer peripheral edge faces are further polished using a brush.

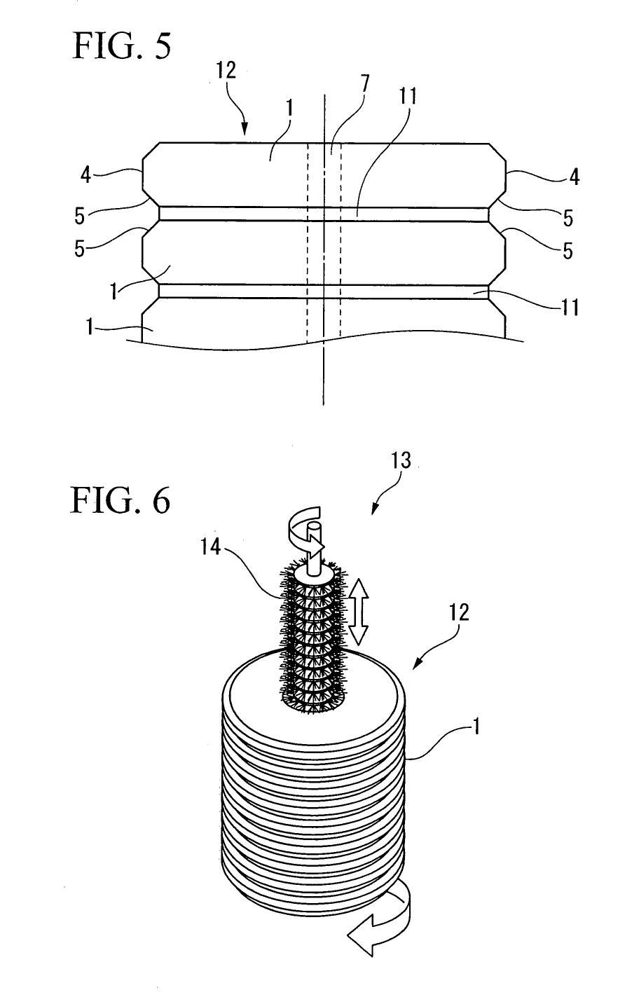

For the brush polishing, a stack of silicon substrates 12 as shown in FIG. 5 is used. The stack of silicon substrates 12 is a plurality of silicon substrates 1 that are stacked with spacers 11 inserted between the silicon substrates.

The spacers 11 are provided in order to reliably prevent any part of the chamfer sections 5 and 6 from missing being polished by a polishing brush, and to reliably prevent the silicon substrates from being damaged during polishing. They are disc-shaped with a circular hole in the center similar to the silicon substrates. To be specific, they are formed such that the edges (side faces) of the spacers 11 are approximately 0 to 2 mm inside (preferably, approximately 0.5 to 2 mm inside) the ends of the outer peripheral chamfer sections 5 of the silicon substrates when they are mounted. If the edges of the spacers are further in than the ends of the chamfer sections of the silicon substrate, a brush entering the region of the main surface of the silicon substrate can cause the ridge sections between the main surfaces and the chamfer sections to become rounded, depending on the thickness of the spacers and the bristle diameter of the brush. Furthermore, the thickness of the spacers 11 is adjusted appropriately depending on the bristle diameter of the brush used. The thickness is preferably approximately 0.1 to 0.3 mm. Moreover, for the material of the spacers 11, it is preferable to use materials that are softer than the silicon substrate, such as polyurethane, acrylic resins, epoxy, the same material as the polishing pad used in the polishing process, or the like. It is preferable to use a material that is soft enough to prevent the silicon substrate from being damaged by the pressure from the polishing brush or the polishing pad.

In the polishing operation, firstly, a large number of alternating silicon substrates and spacers are inserted on a tool (not shown in the figure), and by fitting covers and clamping them together, a stack of silicon substrates is formed. Next, the polishing brush is inserted in the central holes of the silicon substrates 1, and the amount of pressure of the polishing brush is adjusted so that the bristles make contact with the inner peripheral edge faces of the silicon substrates.

It is desirable to use a polishing brush formed from bundles of polyamide fibers with a diameter of 0.05 mm to 0.3 mm, and a length of 1 to 10 mm, formed in a spiral.

Next, a substrate case is filled with an adequate amount of polishing liquid. Then, as shown in FIG. 6, the stack of silicon substrates 12 and the polishing brush 13 are moved up and down, while being rotated in opposite directions to each other, for the brush to polish the substrate inner peripheral surfaces. Preferably, the speed of rotation of the stack of silicon substrates 12 is 60 rpm, and the speed of rotation of the polishing brush 13 is approximately 1000 to 3000 rpm.

By polishing the inner peripheral surfaces using the brush, the intersections of the main surface and the inner peripheral chamfer sections develop into curved surfaces with a radius of 0.01 to 0.3 mm.

Next, the outer peripheral edge faces of the silicon substrates are polished using the brush, after the brush polishing of the inner peripheral edge faces.

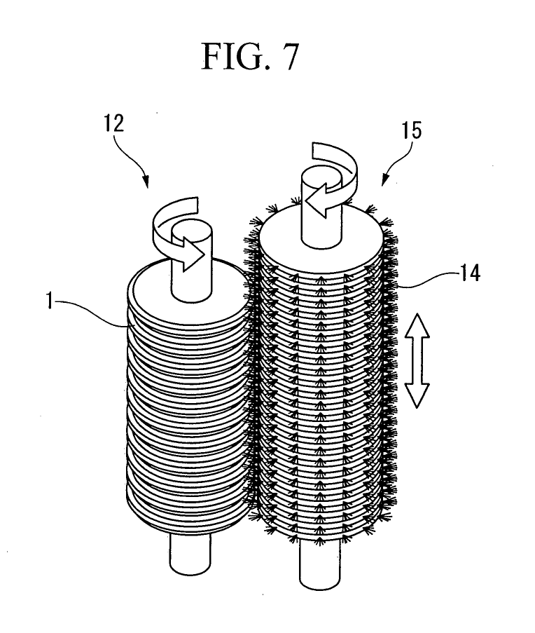

As shown in FIG. 7, a cylindrical brush 15 is pressed onto the edge faces of the silicon substrates 1 of the stack of silicon substrates 12. It is desirable to use a cylindrical brush 15 with a diameter of 200 to 500 mm in which the bristles are polyamide fibers, with a diameter of 0.05 mm to 0.3 mm, and a length of 10 to 30 mm, formed in a spiral. The cylindrical polishing brush is pressed onto the outer peripheral sections of the stack of silicon substrates, and a polishing liquid is supplied to the surfaces where the outer peripheral sections of the stack of silicon substrates and the polishing brush make contact.

Next, the stack of silicon substrates 12 and the cylindrical brush 15 are moved up and down while being rotated in opposite directions to each other at 60 rpm and 700 to 1000 rpm respectively, for brush polishing of the outer peripheral edge faces of the silicon substrates 1.

The silicon substrates that have completed brush polishing are washed in water, and a first polishing process is performed on their surfaces.

The first polishing process aims to remove residual scratches and distortion from the processes up to the above.

The first polishing process uses a typical polishing device, uses colloidal silica+water as a polishing liquid, and is performed with a load of approximately 100 gf/cm² (0.98N/cm² (relative pressure)), lower surface revolution speed: 40 rpm, upper surface plate revolution speed: 35 rpm, sun gear revolution speed: approximately 14 rpm, and internal gear revolution speed: approximately 29 rpm.

The silicon substrates that have completed the first polishing process as described above are washed in water, and transferred to a second polishing process.

Next, the final, second polishing process is performed on the silicon substrates that have completed the first polishing process. The polishing conditions of the second polishing process, which is the finish polishing process are: colloidal silica+water is used as a polishing liquid, the load is reduced to approximately 100 gf/cm² (0.98N/cm² (relative pressure)), lower surface revolution speed: 40 rpm, upper surface plate revolution speed: 35 rpm, sun gear revolution speed: approximately 14 rpm, and internal gear revolution speed: approximately 29 rpm.

The silicon substrates that have completed the second polishing process as described above are immersed in washing tanks of neutral detergent, pure water, pure water+IPA (isopropyl alcohol), and IPA (steam drying) in sequence to wash them.

Through the above processes, silicon substrates for magnetic recording media can be obtained in which the edge faces of the substrates and the chamfer sections are of a mirror finish, and curved surfaces with a radius of greater than or equal to 0.01 mm and less than 0.3 mm are interposed between the main surfaces of the substrates and the chamfer sections.

Although the material of the silicon substrates for magnetic recording media is silicon, which is fragile, it is difficult for chips on the substrate edge faces and cracks on the substrates to be produced, debris can be prevented from being produced from the substrate edge faces, and debris can be prevented from being produced by rubbing against a process cassette.

If a CrMo underlayer, a CoCrPtTa magnetic layer, and a carbon hydride protective layer are formed on the two sides of the silicon substrate for a magnetic recording medium obtained as above in sequence according to a known conventional method, for example by using an inline type sputtering device or the like and forming a perfluoro polyether liquid lubricant film using a dipping method, then a magnetic recording medium can be obtained.

A magnetic recording medium of the present invention that can be obtained in this manner has a curved surface with a radius of greater than or equal to 0.01 mm and less than 0.3 mm between the main surface of the substrate and the chamfer sections, so it is difficult for chips on the magnetic recording medium edge faces and cracks on the substrate to be produced, debris can be prevented from being produced from the magnetic recording medium edge faces, and debris can be prevented from being produced by rubbing against a process cassette. Therefore, it is effective in preventing errors during recording and reproduction, and crashes of a magnetic head during recording and reproduction.

### EMBODIMENT

A silicon substrate with a diameter of 150 mm (nominal: 6 inches) was prepared, a first stage lapping process, a laser cutting process, a second lapping process, an inner and outer peripheral chamfer process, an inner and outer peripheral edge brushing process, a main surface first polishing process, and a main surface second polishing process, were performed in sequence, and twenty 0.85 inch silicon substrates with a shape as shown in Table 2 were produced.

A stack of silicon substrates, in which spacers made from epoxy resin with a diameter of 21 mm and a thickness of 0.2 mm were inserted between the silicon substrates, was used in the polishing process and the brushing process of the inner and outer peripheral edge faces.

In the brushing process of the inner peripheral edge faces, a polishing brush formed from a bundle of polyamide fibers with a diameter of 0.1 mm and a length of 5 mm, formed in a spiral, was used, and a polishing liquid was used in which aluminum oxide abrasive grain of grain size #3000 was suspended in water. The polishing brush was inserted in the central holes of the silicon substrate stack, and the brush and the silicon substrate stack were rotated in opposite directions to each other for polishing where the revolution speed of the silicon substrate stack was 60 rpm, and the revolution speed of the polishing brush was 6000 rpm.

Next, after completion of the brush polishing of the inner peripheral edge faces of the silicon substrate, the outer peripheral edge faces were polished using the brush.

For the brush polishing of the inner peripheral edge faces, a cylindrical brush with a diameter of 300 mm was used, with a bristle diameter of 0.1 mm and a length of 20 mm, in which the bristles were polyamide fibers, formed in a spiral. The polishing brush was pressed onto the edge faces of the silicon substrates in the stack of silicon substrates, and a polishing liquid was supplied to the surfaces where the outer peripheral sections of the stack of silicon substrates and the polishing brush made contact, while the stack of silicon substrates and the cylindrical brush were rotated in opposite directions to each other at 60 rpm and 1500 rpm respectively, for polishing.

The dimensional accuracy of the silicon substrate was observed in the vicinity of the outer peripheral edge faces of 20 silicon substrates obtained in this manner, and the results are shown in Table 2.

TABLE 2

| | | Example | |
|---|---|---|---|
| | | of present | Comparative |
| | | invention | example |
| Length of outer | Average | 0.075 | 0.073 |
| peripheral chamfer | Maximum | 0.097 | 0.097 |
| sections | Minimum | 0.06 | 0.051 |
| (L: mm) | Standard deviation | 0.0095 | 0.0114 |
| Radius of curved | Average | 0.041 | 0.005 |
| surface | Maximum | 0.052 | 0.01 |
| (R: mm) | Minimum | 0.031 | 0.001 |
| | Standard deviation | 0.0064 | 0.00283 |
| Scratches on edge | Vertical scratches | 0.1 | 0.15 |
| faces and chamfer | Horizontal scratches | 0.2 | 0.25 |
| sections | Pits | 0 | 0 |
| (per unit) | | | |

| | | |
|---|---|---|
| Number of | 0 out of 20 | 0 out of 20 |
| defective products | (zero) | (zero) |

Next, the 20 silicon substrates were subjected to vibration similar to that which they can be expected to receive when they are stored and moved in cassettes for transport, and the condition of the damage occurring on the substrate edge faces, and the appearance of debris produced, were examined.

The condition of the damage occurring on the substrate edge faces was examined by observing the substrate edge faces using an optical microscope. Furthermore, a debris production test was performed by the following procedure using the cassettes for transport.

(1) The silicon substrates were inserted in the cassette, and the the top cover was fitted, and the silicon substrate is packaged.

(2) To simulate transport, the silicon substrates were moved ten times towards both the bottom and top of the cassette.

(3) To simulate loading and unloading of the cassette, the silicon substrates were inserted into and removed from the grooves of the cassette.

After the above-described processes (1), (2), and (3) have been completed, the number of polycarbonate particles, being the cassette material, produced on the substrate outer peripheral sections was measured using an optical microscope. Measurements were performed by observation of 20 substrates, and a comparison was performed using the value of the number of particles counted divided by the number (20) of the substrates. The results are shown in Table 3.

TABLE 3

| | Example | |
|---|---|---|
| | of present | Comparative |
| | invention | example |
| Rate of chip occurrence in | 0.2 | 0.6 |
| periphery of substrate (%) | | |

### COMPARATIVE EXAMPLE

For comparison, a silicon substrate (comparative example) in which a curved surface with a radius of 0.05 mm was interposed between the main surface of the substrate and the chamfer section was evaluated similarly. The results are also listed in Table 3.

These results show that in a substrate whose material is fragile, if a curved surface with a radius of greater than or equal to 0.01 mm and less than 0.3 mm is provided between the main surface of the substrate and the chamfer section, it is not prone to chips being produced on the substrate edge faces or cracks on the substrate, it is possible to prevent debris from being produced from the substrate edge faces, and it is also possible to prevent debris from being produced by rubbing against a process cassette.

1. A silicon substrate for a magnetic recording medium, comprising a chamfer section between a main surface of the substrate and an edge face, wherein said edge face and chamfer section of said substrate are of mirror finish, and a curved surface with a radius of greater than or equal to 0.01 mm and less than 0.3 mm is interposed between the main surface of said substrate and the chamfer section.

2. A silicon substrate for a magnetic recording medium according to claim 1, wherein said chamfer section between the main surface and the edge face is on an outer peripheral side of the substrate.

3. A silicon a silicon substrate for a magnetic recording medium according to claim 1, wherein said chamfer section between the main surface and the edge face is on an inner peripheral side of the substrate.

4. A silicon substrate for a magnetic recording medium according to claim 1, wherein a length of said chamfer section is 0.05 to 0.16 mm.

5. A silicon substrate for a magnetic recording medium according to claim 1, wherein said silicon substrate is a disc-shaped substrate with a circular hole in the center, and a dimensional accuracy of a diameter of said circular hole in the center is within ±20 μm.

6. A silicon substrate for a magnetic recording medium according to claim 1, wherein a surface roughness of said edge face and said chamfer section is less than or equal to 1 μm Rmax.

7. A silicon substrate for a magnetic recording medium according to claim 1, wherein a surface roughness of said main surface of said substrate is less than or equal to 10 nm Rmax.

8. A method of manufacturing a silicon substrate for a magnetic recording medium, comprising: a process for immersing a disc-shaped silicon substrate with a circular hole in its center in a polishing liquid containing free abrasive grain, and polishing an outer peripheral edge face and/or an inner peripheral edge face of said silicon substrate by rolling contact with a polishing brush.

9. A method of manufacturing a silicon substrate for a magnetic recording medium according to claim 8, wherein said polishing process by rolling contact with a polishing brush is performed after chamfering the inner and outer peripheries.

10. A method of manufacturing a silicon substrate for a magnetic recording medium according to claim 8, wherein a brush made from polyamide resin is used as said polishing brush.

11. A magnetic recording medium wherein at least a magnetic layer is formed on a main surface of a silicon substrate for a magnetic recording medium according to claim 1.
